(19) United States
(12) Patent Application Publication
(10) Pub. No.: US 2012/0193275 A1
(43) Pub. Date: Aug. 2, 2012

(54) FILTER ELEMENT USING PLASTIC CAP INTEGRATED WITH RELIEF VALVE

(76) Inventor: Jang Soo Kim, Ansan-shi (KR)

(21) Appl. No.: 13/501,080

(22) PCT Filed: Oct. 9, 2009
(86) PCT No.: PCT/KR2009/005810

§ 371 Date: Apr. 9, 2012

(51) Int. Cl. B01D 27/10

(52) U.S. Cl. 210/130

(57) ABSTRACT

The present invention relates to a filter element using a plastic cap integrated with a relief valve, wherein a net type core 21 is received in a spin-on filter housing 10 in the cylindrical shape opened at the top portion thereof and formed with a plurality of oil passing holes 21a in the periphery thereof, and an oil pleated paper 22 is positioned to maintain the shape thereof at the periphery of the core 21 so as to be positioned at a small distance from the inner wall of the housing 10. The filter element 20 includes: an upper cap 23 formed of a plastic material at the upper end thereof; and a fixed lower cap 50 integrated with a relief valve formed of plastic material at the lower end thereof. The fixed lower cap 50 integrated with a relief valve receives and fixes a relief valve 30, which is formed of a valve plate 32 and an elastic spring 33. In the filter element 20, the core 21 is covered by the upper cap 23 and the lower cap 50, which are kept in close contact with the outside of the core 21. According to the present invention, assembly of the valve plate 32 and the elastic spring 33 of the relief valve 30 is simplified by integrating a plurality of upper holding protrusions 52 of the fixed lower cap 50 integrated with a relief valve. In addition, the deviation of an element compression spring 25 closely contacting the lower inner surface of the housing 10 by the oil which is introduced into an oil hole 53 is prevented by the integration of the lower holding protrusions 52. Furthermore, the upper cap 23, the fixed lower cap 50 integrated with a relief valve and the core 21 are manufactured by plastic injection molds so as to reduce weight. The spin-on filter may be reused without separation from the oil pleated paper 22, which is fixed by a thermosetting resin 22a (since both are formed of the same materials) when discarding the spin-on filter. In addition, it is possible to use the element in the generation of renewable energy.

### TECHNICAL FIELD

The present invention relates to a filter element using a plastic cap integrated with a relief valve, and more particularly, to a filter element using a relief valve-integrated plastic cap, which is configured by forming a fixing structure for a spring installed within a spin-on filter housing, and integrating the filter element and a bottom cap with each other.

### BACKGROUND ART

Since an automotive engine includes a plurality of frictional elements, the power of the engine is greatly deteriorated due to frictional resistance. It is well-known that oil is supplied to each of the frictional elements in order to reduce such deterioration of engine power.

Since it is necessary to convert oil to hydraulic fluid in order to supply the oil to each of the frictional elements, there is provided an oil pump that receives power from the engine.

The oil pump is installed in a crank case of an engine to supply oil contained within the case to the inner wall of a cylinder and the outer wall of a piston, in which the oil pump supplies the oil to a valve and a valve opening/closing means positioned on the top of the cylinder through a predetermined passage.

In such a case, the oil supplied to each of the frictional elements conducts a lubrication action while moving metallic powders or other foreign matter produced from the frictional elements to the crank case to prevent the abrasion of the crank case and bearings, and to clean the surface of each of the frictional elements.

However, since the metallic powders and foreign matter moved to the crank case may be pumped to the frictional elements again when the oil pump is driven, a spin-on filter configured to filter the metallic powders and foreign matter is provided at the outlet side of the oil pump.

The term, spin-on filter is intended to cover an oil filter, a fuel filter, a hydraulic filter, a cooling filter or the like that is used for an internal combustion engine or for an industrial purpose or the like.

The spin-on filter is provided with an element that is fabricated in a predetermined shape and installed substantially in a cylindrical shape, and a relief valve that is provided at the central area of the element to prevent the spin-on filter from being damaged when the oil pressure is increased over a predetermined level, and to serve as another passage for supplying oil to be introduced into the engine when a filter, i.e. an oil pleated paper is blocked.

FIGS. 1 and 2 show a conventional oil filter, which includes a top-opened cylindrical housing 10, and a filter element 20 received in the housing 10 to filter oil.

The filter element 20 includes a core 21 formed with a plurality of oil passing holes 21a around the periphery thereof, and an oil pleated paper 22 arranged to surround the periphery of the core 21 to maintain the shape thereof, and spaced at a small distance from the inner peripheral wall of the housing 10.

In order to stabilize oil flow and to maintain the pressure over the entirety of the filter constantly, a relief valve 30 is installed on an inner bottom side of the core 21, in which the relief valve 30 is adapted to be operated when the oil filter is increased over a set pressure.

The filter element 20 is configured to be kept in close contact with the outside of the core 21 by being covered by top and bottom caps 23 and 24 at the upper and bottom ends thereof, respectively. The top cap 23 is arranged to be compressed against a reinforcement plate 40, and the bottom cap 24 is elastically supported by a leaf spring 25 which is in close contact with the lower inside of housing 10, so that the oil filter can be tightly installed to an oil supply line.

The reinforcement plate 40 is positioned to be in contact with the inner peripheral wall of the housing 10, and to be retained in a fixed state by a seaming cap 41 fixedly seamed the periphery of the top end of the housing 10.

Specifically, the seaming cap 41 and the housing 10 are formed of a metallic material, and the peripheral edge area of the seaming cap 41 and the periphery of the top end of the housing 10 are joined to each other by being bent and seamed to each other so that they cannot be detached from each other. A curved groove is formed on the seaming cap 41 so that a packing member 42 can be seated in the groove.

In addition, the relief valve 30 is received in a valve cap 31 which is in turn projection-welded to the inside of the bottom cap 24.

When the oil pleated paper 22 is blocked, the relief valve 30 allows unfiltered engine oil to flow through the relief valve 30 to prevent the increase of pressure. In the inside of the valve cap 31, there is provided a valve plate 32 configured to be pressed against on the top side of an opened hole 24a formed at the center of the bottom cap 24, and an elastic spring 33 configured to press the top side of the valve plate 32 within the valve cap 31.

The oil pleated paper 22 is adapted to be sealed at the top and bottom ends thereof by coating a thermosetting resin 22a with a predetermined thickness on the top and bottom caps 23 and 24 positioned on the top and bottom ends, respectively, and then heating the thermosetting resin 22a to 160° C. to 180° C. in a conveyor oven for 10 to 20 minutes to cure the thermosetting resin 22a.

Now, a process for assembling and fabricating the filter element of the spin-on filter configured as disclosed above will be described. At first, the valve plate 32 configured to cover the opened hole 24a is positioned on the top side of the bottom cap 24, and the top side of the valve cap 31, in which the elastic spring 33 adapted to press the top side of the valve plate 32 is received, is welded to the top side of the bottom cap 24. Then, the cylindrical core 21 is installed on the top side of the bottom cap 24 in a state in which the relief valve 30 is positioned at the center of the top side of the bottom cap 24.

The oil pleated paper 22 is positioned to surround the outer periphery of the core 21. The thermosetting resin 22a for sealing the top and bottom sides of the oil pleated paper 22 is coated to the top and bottom sides of the oil pleated paper 22, then the top and bottom caps 23 and 24 are positioned on the top and bottom sides of the oil pleated paper 22, and then the thermosetting resin 22a is heated to 160° C. to 180° C. in a conveyor oven for 10 to 20 minutes to be cured. As a result, the top and bottom caps 23 and 24 are bonded to the top and bottom sides of the oil pleated paper 22, respectively.

The filter element 20 assembled in this manner is assembled to the inside of the housing 10. Specifically, the leaf spring 26 is inserted into the inner bottom side 10 of the housing 10, i.e. between the bottom surface of the bottom cap 24 and the inner bottom surface of the housing 10, positioning the reinforcement plate 40 on the top side of the top cap 23, and seaming the seaming cap 41 to the periphery of the top end of the housing 10 on the top side of the reinforcement plate 40. As a result, the assembly is completed.

With the oil filter completely assembled in this manner, when engine oil flows into the inside of the oil filter, the oil containing impurity moves from the outside of the oil pleated paper 22 into the inside of the oil pleated paper 22, by which the impurity of the oil is filtered. The oil filtered in this manner is moved into the inside of the core 21 through the oil passing holes 21a, and then ejected to each engine through a chamber.

However, the conventional filter element 20 configured as described above has problems in that since the top and bottom caps 23 and 24 are formed of a steel material, and the valve cap 31, which is also formed of a steel material and receives the elastic spring 23 and the valve plate 32 of the relief valve 32 therein, is welded to the top side of the bottom cap 24, i.e. since the valve cap 31 and the bottom cap 24 are joined to each other through welding, much time is required for manufacturing the filter element. In addition, since the top and bottom caps 23 and 24 are formed of a steel material, the weight of the filter element 20 is heavy, the relief valve 30 and the bottom cap 24 are difficult to be integrated with each other, and the bottom side welding area of the valve cap 31 may be cut off which may prevent the relief valve from being operated.

In addition, there are problems in that since the leaf spring 26, which is employed for pressing the filter element 20 against the housing 10, should be formed of a high strength spring steel, manufacturing costs are increased. In addition, if the height of the filter element 20 installed within the housing 10 is low, the filter element 20 may not be firmly contacted in the housing 10 which will increase the probability to produce defective products.

There are other additional problems in that since the top and bottom sides of the oil pleated paper 22 are configured to be sealed in relation to the upper and lower steel caps 23 and 24 using the thermosetting resin 22a, respectively, in which case the top and bottom sides of the oil pleated paper 22, i.e. the end parts formed by a group of individual lines are finished by being covered by thermosetting resin 22a, there is a disadvantage from an aspect of workability, which makes it difficult to expect a uniform sealing performance over the entire area. In addition, since the oil pleated paper 22 and the top and bottom caps 23 and 24, which are formed of materials different from each other, are joined to each other by thermosetting resin, it is complicated and difficult to separate the top and bottom caps 23 and 24 and the oil pleated paper 22 from each other when the filter element is discarded after use. As a result, the top and bottom caps 23 and 24 and the oil pleated paper 22 are frequently discarded without being separated from each other, which causes environmental pollution.

### DISCLOSURE

### Technical Problem

Therefore, the present invention has been made in view of the above-mentioned problems, and an aspect of the present invention is to provide a filter element using a relief valve-integrated plastic cap configured by forming a structure for fixing a spring installed on the inner bottom surface of a filter housing, and integrating the filter element and a bottom cap with each other.

Another aspect of the present invention is to provide a relief valve-integrated plastic cap configured by directly attaching the upper and bottom surfaces of the oil pleated paper to each other through hot melt, and bonding top and bottom caps, which are integrated with upper and lower cores adapted to be inserted into a central bore formed through the oil pleated paper, to the upper and bottom ends of the oil pleated paper.

### Technical Solution

In accordance with a first aspect of the present invention, there is provided a filter element using a relief valve-integrated plastic cap, including: a net type core received in a top-opened cylindrical spin-on filter housing, and formed with a plurality of oil passing holes around the periphery thereof; an oil pleated paper positioned to surround the periphery of the core to maintain the shape thereof, and to be spaced at a small distance from the inner peripheral wall of the housing; a top cap formed of a plastic material and configured to cover the top end of the oil pleated paper; and a relief valve-integrated and fixed bottom cap formed of a plastic material configured to cover the bottom end of the oil pleated paper and to receive and fix a relief valve, which includes a valve plate and an elastic spring, below the top cap, the oil pleated paper being adapted to be kept in close contact with the outer periphery of the core.

In the filter element using a relief valve-integrated plastic cap in accordance with the first aspect of the present invention, the relief valve-integrated and fixed bottom cap includes: a plurality of upper holding protrusions integrally formed to radially extend toward the center thereof, and configured to receive the elastic spring of the relief valve in the inside thereof; a plurality of lower holding protrusions integrally formed to radially extend toward the center thereof and configured to receive an element compression spring in the inside thereof, the element compression spring being adapted to be in close contact with the inner bottom surface of the housing; and an oil hole centrally formed between the upper and lower holding protrusions and configured to allow oil, which could not pass through the oil pleated paper, to be introduced through the oil hole while being opened/closed by the valve plate of the relief valve.

In accordance with a second aspect of the present invention, there is provided a filter element received in a top-opened cylindrical spin-on filter housing, including: a hollow cylindrical oil pleated paper positioned within the housing to be spaced at a small distance from the inner peripheral wall of the housing; an upper core-integrated top cap configured to cover the top end of the oil pleated paper, and integrally formed with an upper core formed of a plastic material, the upper core being inserted into the central bore of the oil pleated paper from above; and a lower core-integrated bottom cap configured to cover the bottom end of the oil pleated paper, and formed with a lower core of a plastic material, the lower core being inserted into the central bore of the oil pleated paper from below to be hooked with the upper core, the lower core-integrated bottom cap being adapted to receive and fix a relief valve which comprises a valve plate and an elastic spring.

The lower core-integrated bottom cap in accordance with the second aspect of the present invention includes: a plurality of upper holding protrusions integrally formed to radially extend toward the center thereof, and configured to receive the elastic spring 33 of the relief valve in the inside thereof; a plurality of lower holding protrusions 52 integrally formed to radially extend toward the center thereof and configured to receive an element compression spring in the inside thereof, the element compression spring being adapted to be in close contact with the inner bottom surface of the housing; an oil hole centrally formed between the upper and lower holding protrusions, and configured to allow oil, which could not pass through the oil pleated paper, to be introduced while being opened/closed by the valve plate of the relief valve; and a plurality of coupling protrusions formed around the top end of a net-type cylindrical lower core 54, which is integrally formed to surround the upper holding protrusions at a distance from the upper holding protrusions, the coupling protrusions being configured to be coupled to the upper core in a hook type.

Herein, the oil pleated paper is coated with hot melt with a predetermined thickness on the top and bottom ends thereof to be sealed.

### ADVANTAGEOUS EFFECTS

With the filter element using a relief valve-integrated and fixed plastic cap in accordance with the first aspect of the present invention, it is easy to assemble the valve plate and the elastic spring of the relief valve since the upper protrusions of the relief valve-integrated and fixed lower plastic cap are integrally formed. In addition, since the lower holding protrusions are integrally formed, it is possible to prevent the cylindrical spring positioned in close contact with the inner bottom surface of the housing from being moved from its normal position by oil introduced into the oil passing hole. Furthermore, since the top cap, the relief valve-integrated and fixed bottom cap and the cores are formed as injection-molded plastic products, it is possible to lighten the weight of the filter element. Moreover, since they are formed from the same material, it is possible to reuse them without needing to separate them from the oil pleated paper fixed by thermosetting resin when the spin-on filter is discarded, and it is also possible to use them for generating renewable energy.

### BRIEF DESCRIPTION OF THE DRAWINGS

The foregoing and other objects, features and advantages of the present invention will become more apparent from the following detailed description when taken in conjunction with the accompanying drawings in which:

FIG. 1 is a cross-sectional view illustrating a conventional spin-on filter;

FIG. 2 is a cross-sectional view illustrating the bottom cap area of the conventional spin-on filter in detail;

FIGS. 3 and 4 are cross-sectional views illustrating a spin-on filter in accordance with a first exemplary embodiment of the present invention;

FIG. 5 is an exploded perspective view of a part of the inventive filter element;

FIGS. 6 and 7 are cross-sectional views illustrating a spin-on filter in accordance with a second exemplary embodiment of the present invention;

FIG. 8 is an exploded perspective view of a part of the inventive filter element;

FIG. 9 illustrates a process of manufacturing an a oil pleated paper of the inventive filter element; and

FIG. 10 is a perspective view a net type core of the inventive filter element, which is formed by half-cylindrical parts.

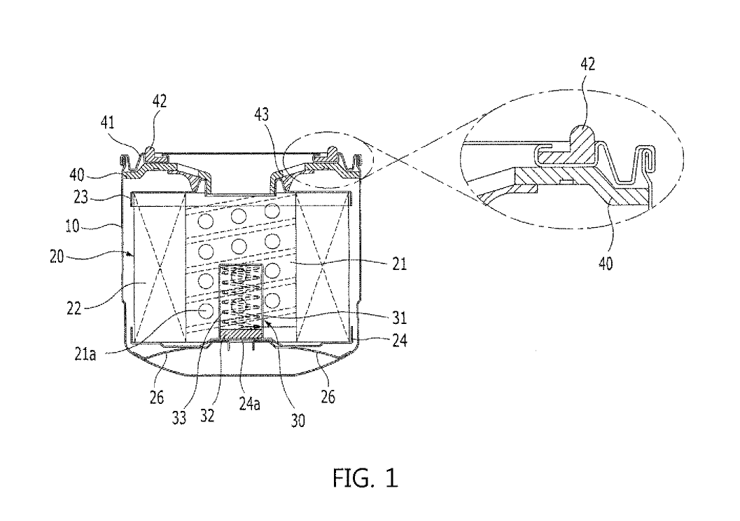

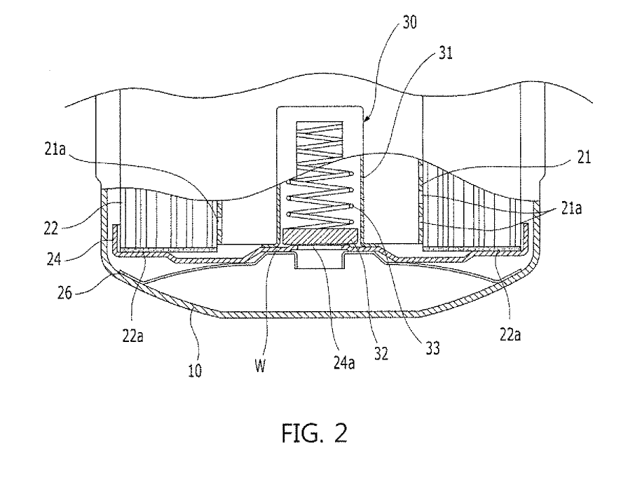

### DESCRIPTION OF MAJOR REFERENCE NUMERALS IN THE DRAWINGS

10: housing

20: filter element

21: net type core

22: oil pleated paper

23: top cap

35: cylindrical spring

30: relief valve

32: valve plate

33: elastic spring

50: relief valve-integrated and fixed bottom cap

51: upper holding protrusions

52: lower holding protrusions

53: oil hole

54: lower core

55: coupling protrusions

60: upper core-integrated top cap

61: upper core

70: lower core-integrated bottom cap

### BEST MODE

In accordance with a first aspect of the present invention, there is provided a filter element using a relief valve-integrated plastic cap, including: a net type core received in a top-opened cylindrical spin-on filter housing, and formed with a plurality of oil passing holes around the periphery thereof; an oil pleated paper positioned to surround the periphery of the core to maintain the shape thereof, and to be spaced at a small distance from the inner peripheral wall of the housing; a top cap formed of a plastic material and configured to cover the top end of the oil pleated paper; and a relief valve-integrated and fixed bottom cap formed of a plastic material configured to cover the bottom end of the oil pleated paper and to receive and fix a relief valve, which includes a valve plate and an elastic spring, below the top cap, the oil pleated paper being adapted to be kept in close contact with the outer periphery of the core.

In the filter element using a relief valve-integrated plastic cap in accordance with the first aspect of the present invention, the relief valve-integrated and fixed bottom cap includes: a plurality of upper holding protrusions integrally formed to radially extend toward the center thereof, and configured to receive the elastic spring of the relief valve in the inside thereof; a plurality of lower holding protrusions integrally formed to radially extend toward the center thereof and configured to receive an element compression spring in the inside thereof, the element compression spring being adapted to be in close contact with the inner bottom surface of the housing; and an oil hole centrally formed between the upper and lower holding protrusions and configured to allow oil, which could not pass through the oil pleated paper, to be introduced through the oil hole while being opened/closed by the valve plate of the relief valve.

### MODE FOR INVENTION

Now, exemplary embodiments of the present invention will be described in detail with reference to accompanying drawings.

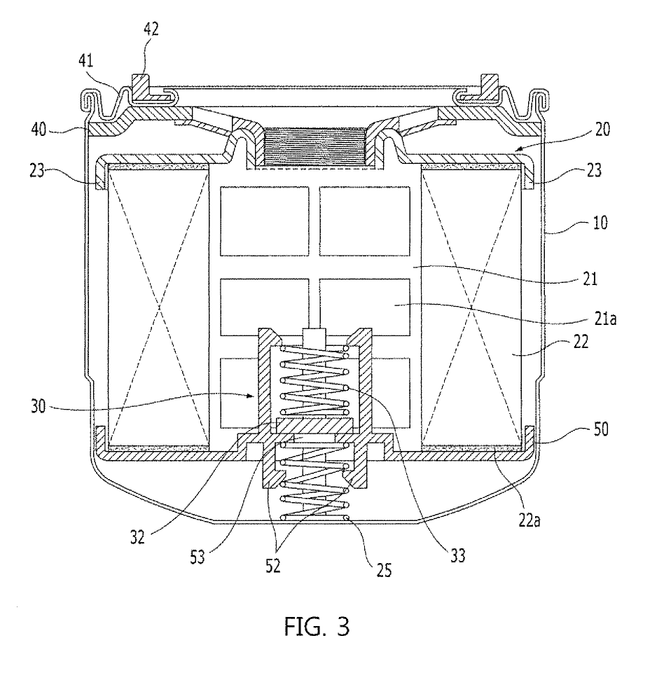

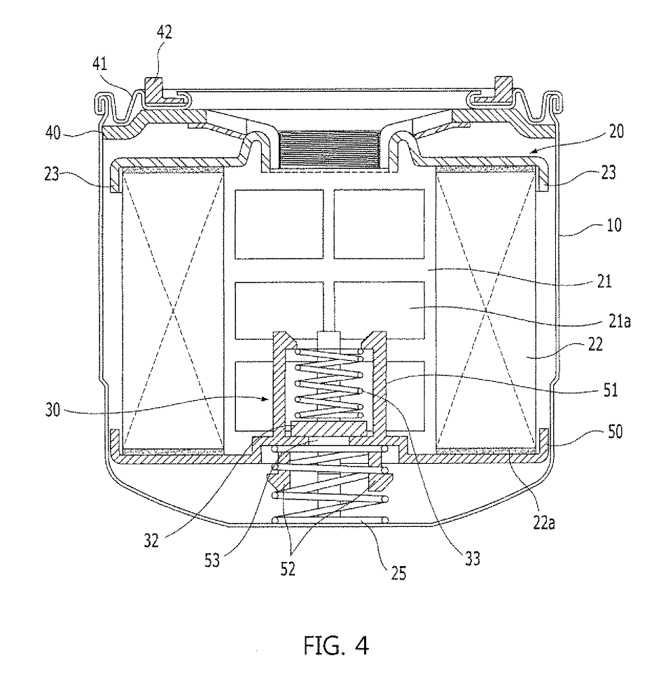

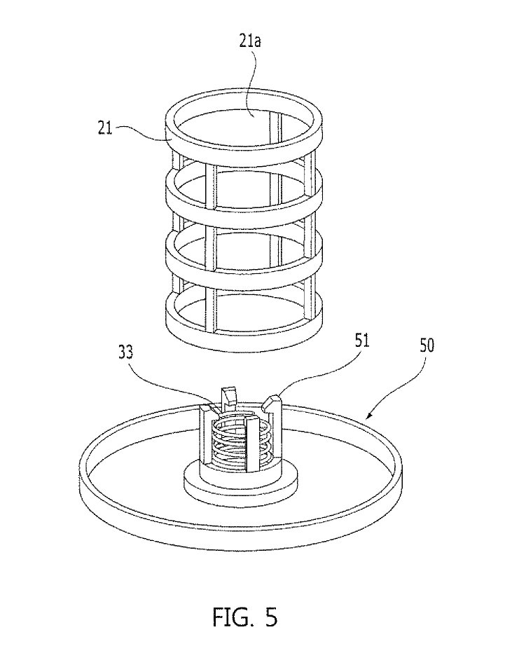

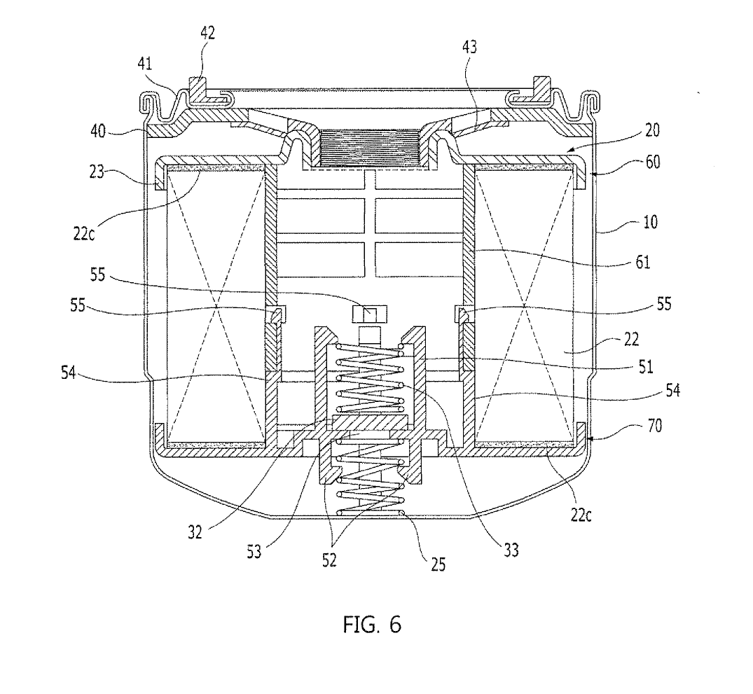

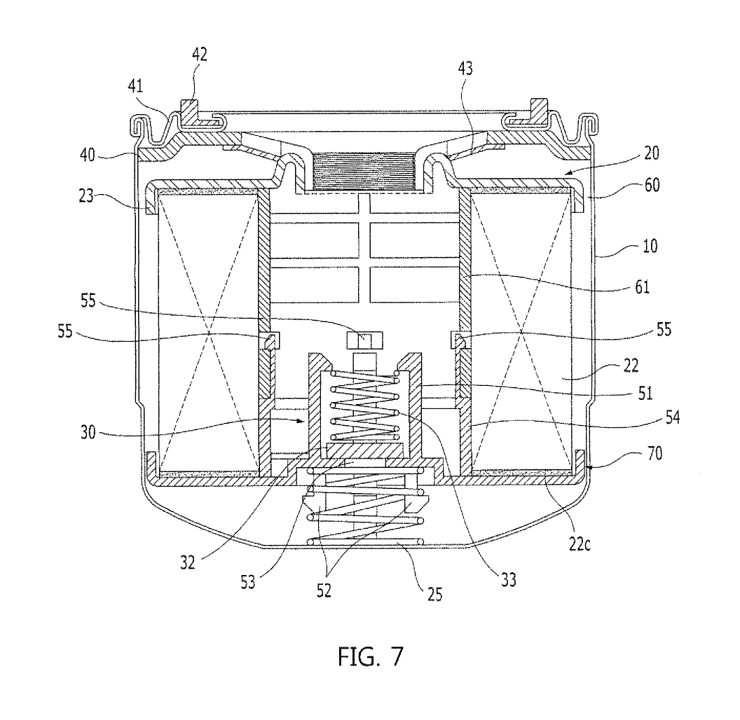

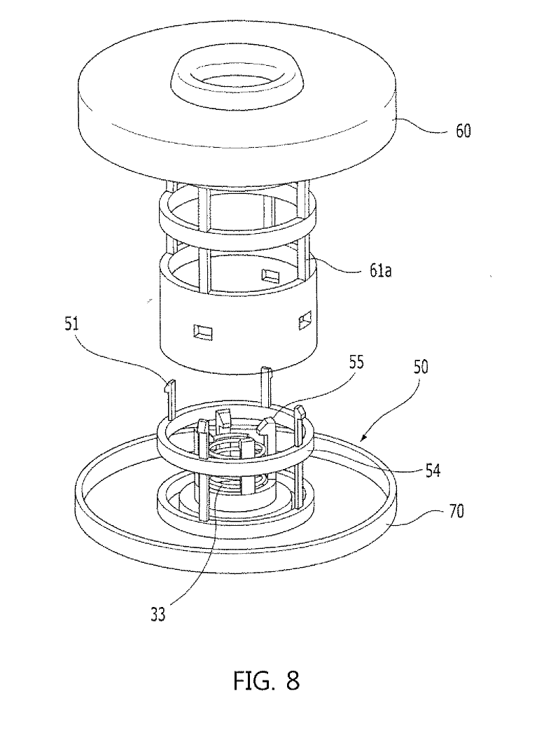

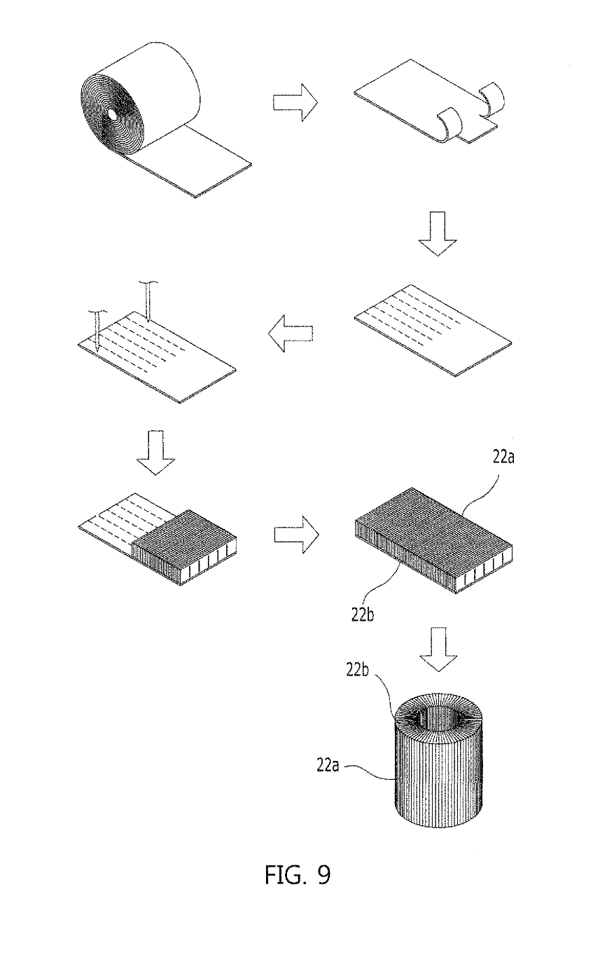

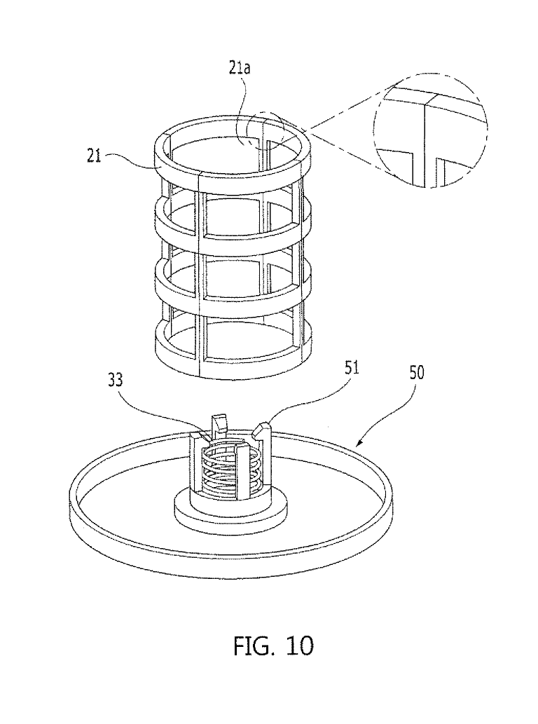

FIGS. 3 and 4 are cross-sectional views illustrating a spin-on filter in accordance with the first exemplary embodiment of the present invention, and FIG. 5 is an exploded perspective view of a part of the inventive filter element. FIGS. 6 and 7 are cross-sectional views illustrating a spin-on filter in accordance with the second exemplary embodiment of the present invention, and FIG. 8 is an exploded perspective view of a part of the inventive filter element. In addition, FIG. 9 illustrates a process of manufacturing an oil pleated paper of the inventive filter element, and FIG. 10 is a perspective view of a net type core of the inventive filter element, which is formed by half-cylindrical parts.

At first, the first exemplary embodiment of the present invention will be described with reference to FIGS. 3 and 5.

The inventive spin-on filter includes a top-opened cylindrical housing 10, and a filter element 20 received in the housing 10 to filter oil.

The filter element 20 includes a net type core 21 formed with a plurality of oil passing holes 21a around the periphery thereof, and an oil pleated paper 22 arranged to surround the periphery of the core 21 to maintain the shape thereof and to be spaced at a small distance from the inner peripheral wall of the housing 10.

The filter element 20 is covered by a top cap 23 formed of a plastic material at the top end thereof, and by a relief valve-integrated and fixed bottom cap 50 formed of a plastic material and configured to receive and fix a relief valve 30, which includes a valve plate 32 and an elastic spring 33, at the bottom end thereof, so that the filter element 20 can be kept to be in close contact with the outside of the core 21.

The oil pleated paper 22 is configured to be sealed in relation to the top cap 23 and the relief valve-integrated and fixed bottom cap 50 at the top and bottom sides thereof by a thermosetting resin 22a with a predetermined thickness.

The relief valve-integrated and fixed bottom cap 50 includes: a plurality of upper holding protrusions 51 integrally formed to protrude radially toward the center thereof to receive the elastic spring 33 of the relief valve 30 in the inside thereof; a plurality of lower holding protrusions 52 integrally formed to protrude radially toward the center thereof to receive an element compression spring 25 in the inside thereof, the element compression spring 25 being adapted to be in close contact with the inner bottom surface of the housing 10; and an oil hole 53 centrally formed between the protrusions 51 and 52 to be opened/closed by the valve plate 32 of the relief valve 30 to allow oil, which could not pass through the oil pleated paper 22, to be introduced through the oil hole 53.

Since the upper holding protrusions 52 of the relief valve-integrated and fixed bottom cap 50 are integrally formed, it is easy to assembly the valve plate 32 and the elastic spring 33 of the relief valve 30. In addition, since the lower holding protrusions 52 are integrally formed, it is possible to prevent the element compression spring 25 from being separated away from its normal position by the oil introduced into the oil hole 53.

The reason why it is possible to integrate the upper and lower holding protrusions 51 and 52 to the relief valve-integrated and fixed bottom cap 50 in such a manner that they can receive the relief valve 30 and the element compression valve 25 as described above is because the relief valve-integrated and fixed bottom cap 50 is fabricated as an injection-molded product, i.e. from a plastic material.

By manufacturing the top cap 23, the relief valve-integrated and fixed bottom cap 50, and the core as injection molded products, it is possible to lighten their weight. In addition, since they are formed from the same material, it is possible to reuse them without needing to separate them from the oil pleated paper fixed by the thermosetting resin 22a when discarding the spin-on filter, and to use them to generate renewable energy.

Next, the second embodiment of the present invention will be described with reference to FIGS. 6 to 8.

The spin-on filter in accordance with the second exemplary embodiment of the present invention includes a top-opened cylindrical housing 10, and a filter element 20 received in the housing 10 to filter oil.

The filter element 20 includes: a hollow cylindrical oil pleated paper 22 positioned to be spaced at a small distance from the inner peripheral wall of the housing 10; an upper core-integrated top cap 60 configured to cover the top end of the oil pleated paper 22, and integrally formed with an upper core 61 formed of a plastic material, the upper core 61 being inserted into the central bore of the oil pleated paper 22 from above; and a lower core-integrated bottom cap 70 configured to cover the bottom end of the oil pleated paper 22, and integrally formed with a lower core 54 formed of a plastic material, the lower core 54 being inserted into the central bore from below to be hooked to the upper core 61, and the lower core-integrated bottom cap 70 being configured to receive and fix a relief valve 30 that includes a valve plate 32 and an elastic spring 33.

The oil pleated paper 22 comes into close contact with the upper core-integrated top cap 60 and the lower core-integrated bottom cap 70 which are positioned on the top and bottom ends of the oil pleated paper 22, respectively.

Now, a process for manufacturing the oil pleated paper 22 is described. A conventional roll-type material of the oil pleated paper 22 is extended and continuously supplied. The material of the oil pleated paper 22 at this time has a sufficient width to be capable of covering all of the various standards. Since a spin-on filter has a size that is varied depending on the types of vehicles employing the spin-on filter, the material of the oil pleated paper 22 supplied in this manner is cut in accordance with a predetermined standard, i.e. in a width suitable for a corresponding standard of an oil or fuel filter.

The material of the oil pleated paper 22 cut along opposite longitudinal edge areas to have a predetermined standard width is formed with a plurality of embossing spots on a surface thereof at predetermined intervals while being fed forward. The embossing spots serve to secure a space to a certain extent to be between the materials to be in close contact with each other, thereby reducing load related to spin-on filtering. However, since a meaningful problem is not caused in the spin-on filtering action even without embossing spots, the embossing process may be selectively applied as desired.

Hot melt 22b is applied to the opposite longitudinal edges of the material of the oil pleated paper 22 cut in a suitable width while the oil pleated paper 22 is being continuously fed forward. At this time, merely upon being dropped from above the material of the oil pleated paper 22, the hot melt 22b can be naturally applied while forming a single line to the material which is continuously being fed. The oil pleated paper 22 fed forward in a state in which hot melt 22b is applied at the opposite longitudinal edges thereof is alternately folded left and right at regular intervals using a folding means, and then the opposite ends of the folded material are bonded to each other so that the folded material is shaped into the final cylindrical shape in which the longitudinal edges applied with hot melt 22b form the upper and bottom ends of the cylindrical shape.

The lower core-integrated bottom cap 70 includes: a plurality of upper holding protrusions 51 integrally formed to extend radially toward the center thereof, and configured to receive the elastic spring 33 of the relief valve 30 in the inside thereof; a plurality of lower holding protrusions 52 integrally formed to extend radially toward the center thereof, and configured to receive the element compression spring 25 to be in close contact with the inner bottom surface of the housing 10; an oil hole 53 centrally positioned between the upper and lower holding protrusions 51 and 52 to be opened/closed by the valve plate 32 of the relief valve to allow oil, which could not pass through the oil pleated paper 22, to be introduced; and a plurality of coupling protrusions 55 extending from the top end of a lower core 54 integrally formed in a net-type cylindrical shape to surround the upper holding protrusions 51 at a predetermined distance from the upper holding protrusions 51, the coupling protrusions 55 being engaged with the upper core 61 in a hook type.

A shock absorption material 22c, such as a non-woven fabric with a predetermined thickness, is attached to each of the upper and bottom ends of the oil pleated paper 22, and comes into close contact with one of the upper core-integrated top cap 60 and the lower core-integrated bottom cap 70.

Since the upper holding protrusions 52 of the lower core-integrated bottom cap 70 are integrally formed, it is easy to assemble the valve plate 32 and the elastic spring 33 of the relief valve 30. In addition, since the lower holding protrusions 52 are integrally formed, the element compression spring 25 adapted to be in close contact with the inner bottom surface of the housing 10 can be prevented from being moved away from its normal position by oil introduced into the oil hole 53.

The reason why it is possible to integrate the upper and lower holding protrusions with the lower core-integrated bottom cap 70 to receive the relief valve 30 and the element compression spring 25 as described above is because the relief valve-integrated and fixed bottom cap 50 is fabricated as an injection molded product, i.e. from a plastic material.

Since the upper core 61 and lower core 54 are integrally formed with the top and bottom caps 60 and 70, respectively, it is needless to fabricate the cores as separate parts. In addition, the bottom cap 70 is formed by injection-molding a plastic material in such a manner that the bottom cap 70 can be engaged with the upper core 61 of the top cap 60 in a hook type, and it is possible to fabricate by applying hot melt 22b to the upper and bottom ends of the oil pleated paper 22, and then pressing and assembling the oil pleated paper 22 to the upper core-integrated top cap 60 and the lower core-integrated bottom cap 70.

As shown in FIG. 8, the net-type core 21 is configured to be formed by molding and assembling half-cylindrical parts.

If the net-type core 20 is fabricated by injection-molding half-cylindrical parts in this manner, it is possible to fabricate more net-type cores 21 as compared to fabricating, i.e. molding each net-type core 21 in a cylindrical shape, within the same length of time.

### INDUSTRIAL APPLICABILITY

A filter element applied to a spin-on filter for filtering engine oil has been described above. However, the term, spin-on filter is intended to cover an oil filter, a fuel filter, a hydraulic filter, a water filter, a cooling filter, etc. that may be employed for an internal engine or for an industrial purpose.

Although the preferred exemplary embodiments of the present invention have been disclosed for illustrative purposes, those skilled in the art will appreciate that various modifications, additions and substitutions are possible, without departing from the scope and spirit of the invention as disclosed in the accompanying claims. Simple modifications, additions and substitutions of the present invention belong to the scope of the present invention, and the specific scope of the present invention will be clearly defined by the appended claims.

1. A filter element using a relief valve-integrated plastic cap, comprising:
a net type core (21) received in a top-opened cylindrical spin-on filter housing (10), and formed with a plurality of oil passing holes (21a) around the periphery thereof;
an oil pleated paper (22) positioned to surround the periphery of the core (21) to maintain the shape thereof, and to be spaced at a small distance from the inner peripheral wall of the housing (10);
a top cap (23) formed of a plastic material and configured to cover the top end of the oil pleated paper (20); and
a relief valve-integrated and fixed bottom cap (50) formed of a plastic material configured to cover the bottom end of the oil pleated paper (20) and to receive and fix a relief valve (30), which comprises a valve plate (32) and an elastic spring (33), below the top cap (23), the oil pleated paper (22) being adapted to be kept in close contact with the outer periphery of the core (21),
wherein the relief valve-integrated and fixed bottom cap (50) comprises:
a plurality of upper holding protrusions (51) integrally formed to radially extend toward the center thereof, and configured to receive the elastic spring (33) of the relief valve (30) in the inside thereof;
a plurality of lower holding protrusions (52) integrally formed to radially extend toward the center thereof and configured to receive an element compression spring (25) in the inside thereof, the element compression spring (25) being adapted to be in close contact with the inner bottom surface of the housing (10); and
an oil hole (53) centrally formed between the upper and lower holding protrusions (51, 52), and configured to allow oil, which could not pass through the oil pleated paper (22), to be introduced through the oil hole (53) while being opened/closed by the valve plate (32) of the relief valve (30).

2. The filter element as claimed in claim 1, wherein the net type core (21) is formed by injection-molding half-cylindrical parts and assembling the half-cylindrical parts to one another.

3. A filter element received in a top-opened cylindrical spin-on filter housing, comprising:
a hollow cylindrical oil pleated paper (22) positioned within the housing (10) to be spaced at a small distance from the inner peripheral wall of the housing (10);
an upper core-integrated top cap (60) configured to cover the top end of the oil pleated paper (22), and integrally formed with an upper core (61) formed of a plastic material, the upper core (61) being inserted into the central bore of the oil pleated paper (22) from above; and
a lower core-integrated bottom cap (70) configured to cover the bottom end of the oil pleated paper (22), and formed with a lower core (54) of a plastic material, the lower core (54) being inserted into the central bore of the oil pleated paper 22 from below to be hooked with the upper core (61), the lower core-integrated bottom cap (70) being adapted to receive and fix a relief valve (30) which comprises a valve plate (32) and an elastic spring (33).

4. The filter element as claimed in claim 3, wherein the lower core-integrated bottom cap (70) comprises:
a plurality of upper holding protrusions (51) integrally formed to radially extend toward the center thereof, and configured to receive the elastic spring (33) of the relief valve (30) in the inside thereof;
a plurality of lower holding protrusions (52) integrally formed to radially extend toward the center thereof and configured to receive an element compression spring (25) in the inside thereof, the element compression spring (25) being adapted to be in close contact with the inner bottom surface of the housing (10);
an oil hole (53) centrally formed between the upper and lower holding protrusions (51, 52), and configured to allow oil, which could not pass through the oil pleated paper (22), to be introduced while being opened/closed by the valve plate (32) of the relief valve (30); and
a plurality of coupling protrusions (55) formed around the top end of a net-type cylindrical lower core (54), which is integrally formed to surround the upper holding protrusions (51) at a distance from the upper holding protrusions (51), the coupling protrusions being configured to be coupled to the upper core (61) in a hook type.

5. The filter element as claimed in claim 3, wherein the oil pleated paper (22) is coated with hot melt (22b) with a predetermined thickness on the top and bottom ends thereof to be sealed.

6. The filter element as claimed in claim 3, wherein the oil pleated paper (22) is provided with a shock absorption material (22c), which is attached to each of the upper and bottom ends thereof, to be in close contact with the upper core-integrated top cap (60) and the lower core-integrated bottom cap (70).
